(19) United States
(12) Patent Application Publication
(10) Pub. No.: US 2017/0355534 A1
(43) Pub. Date: Dec. 14, 2017

(54) DRY BULK PNEUMATIC METERING ASSEMBLY AND METHOD

(71) Applicant: Jay J. Hunt, Conroe, TX (US)

(72) Inventor: Jay J. Hunt, Conroe, TX (US)

(73) Assignee: Baker Hughes Incorporated, Houston, TX (US)

(21) Appl. No.: 15/180,757

(22) Filed: Jun. 13, 2016

(51) Int. Cl. B65G 53/16; E21B 43/26; E21B 43/267

(52) U.S. Cl. CPC B65G 53/16; E21B 43/267; E21B 43/26; B65G 2203/042; B65G 2201/045; B65G 2203/044

(57) ABSTRACT

A dry bulk pneumatic metering system includes a flow line configured for the passage of pneumatically-conveyed bulk material, a bulk material sensor arranged relative to the flow line, the bulk material sensor configured to send a first signal related to a quantity of the bulk material passing in the flow line and within a range of the bulk material sensor, a speed sensor arranged with respect to at least one area of the system, the speed sensor configured to send a second signal related to the speed of gas flow at the at least one area of the system, and a controller arranged to receive the first and second signals and configured to calculate a bulk material flow rate of the bulk material using the first and second signals.

### BACKGROUND

In the drilling and completion industry, the formation of boreholes for the purpose of production or injection of fluid is common. The boreholes are used for exploration or extraction of natural resources such as hydrocarbons, oil, gas, water, and alternatively for CO2 sequestration. To increase the production from a borehole, the production zone can be fractured to allow the formation fluids to flow more freely from the formation to the borehole. The fracturing operation includes pumping fluids at high pressure towards the formation wall to form formation fractures. To retain the fractures in an open condition after fracturing pressure is removed, the fractures must be physically propped open, and therefore the fracturing fluids commonly include solid granular materials, such as sand, generally referred to as proppants. Due to the large amount of fracturing fluid required for some operations, a correspondingly large amount of proppants are required which must be metered out in appropriate quantities to the frac blenders.

One prior method of measuring bulk material flow rate includes using a calibrated screw which moves a known weight per revolution, and then measuring the screw which drops dry products down into a chamber. Another prior method allows dry product to fall by gravity and then counts the particles and calculates the known rate of fall by the particles to calculate rate.

The art would be receptive to alternative systems and methods for determining bulk material flow rate.

### BRIEF DESCRIPTION

A dry bulk pneumatic metering system includes a flow line configured for the passage of pneumatically-conveyed bulk material, a bulk material sensor arranged relative to the flow line, the bulk material sensor configured to send a first signal related to a quantity of the bulk material passing in the flow line and within a range of the bulk material sensor, a speed sensor arranged with respect to at least one area of the system, the speed sensor configured to send a second signal related to the speed of gas flow at the at least one area of the system, and a controller arranged to receive the first and second signals and configured to calculate a bulk material flow rate of the bulk material using the first and second signals.

An operating system including: a material receiving member; and, the dry bulk pneumatic metering system of claim 1, the dry bulk pneumatic metering system further including a discharge portion arranged to discharge the bulk material from the dry bulk pneumatic metering system; wherein the bulk material discharged from the dry bulk pneumatic metering system is delivered to the material receiving member.

A method of determining a bulk material flow rate in a dry bulk pneumatic metering system, the method including: pneumatically conveying bulk material through a flow line of the system; sensing a quantity of the bulk material passing within the flow line and within a range of a bulk material sensor, the bulk material sensor arranged relative to the flow line, the bulk material sensor sending a first signal to a controller of the system; sensing a speed of gas flow at at least one area of the system using a speed sensor, the speed sensor sending a second signal to the controller; and, using the first and second signals in the controller to calculate the bulk material flow rate of the bulk material.

### BRIEF DESCRIPTION OF THE DRAWINGS

The following descriptions should not be considered limiting in any way. With reference to the accompanying drawings, like elements are numbered alike:

FIG. 1 depicts a schematic diagram of one embodiment of a dry bulk pneumatic flow rate determining system;

FIG. 2 depicts a process flow diagram of one embodiment of an assembly incorporating the system of FIG. 1;

FIG. 3 depicts a schematic diagram of the assembly of FIG. 2; and,

FIG. 4 depicts a schematic view of an embodiment of an operational system usable for a downhole fracturing operation at a wellsite.

### DETAILED DESCRIPTION

A detailed description of one or more embodiments of the disclosed apparatus and method are presented herein by way of exemplification and not limitation with reference to the Figures.

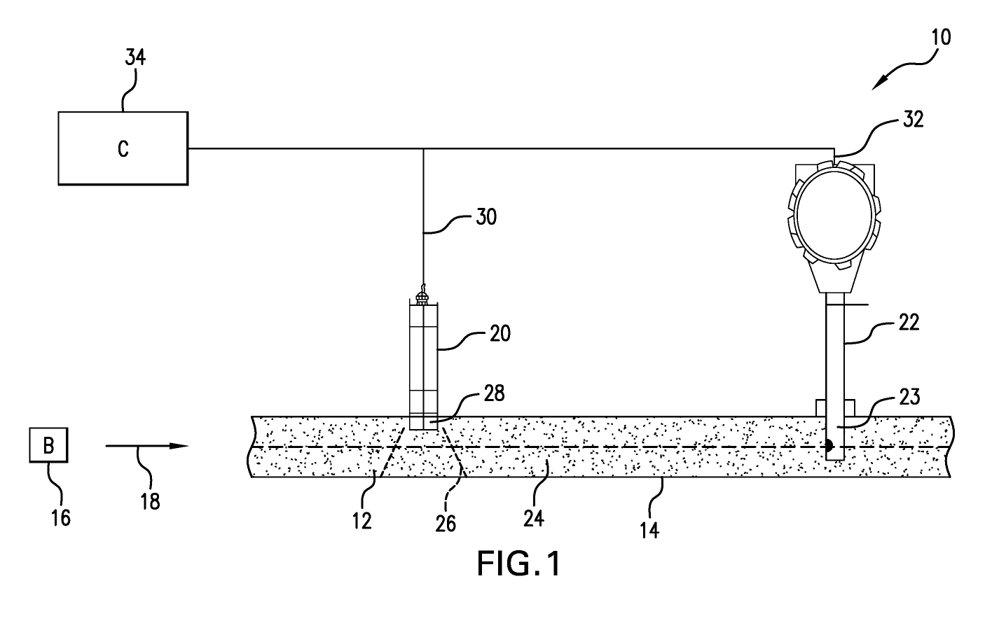

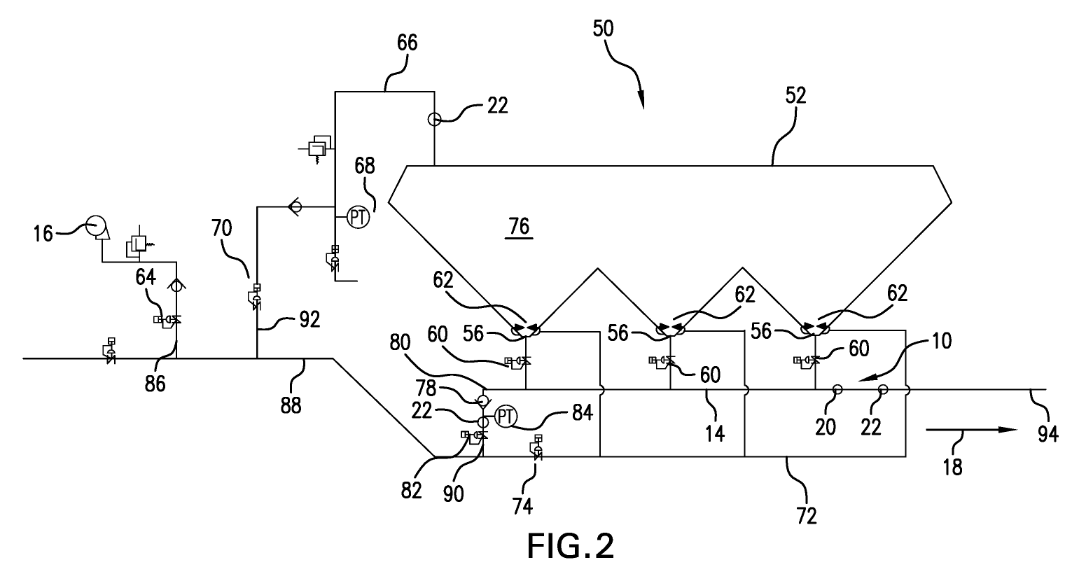

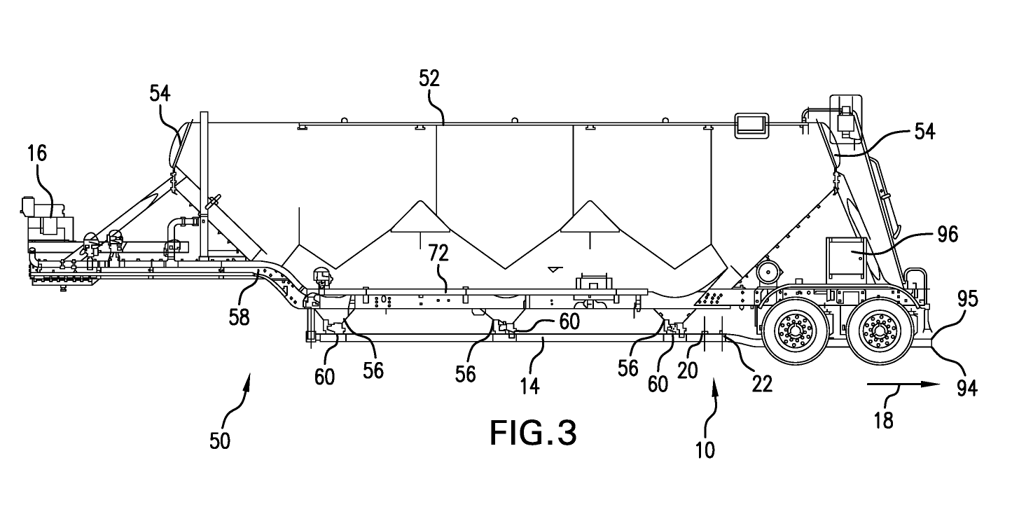

One embodiment of a dry bulk pneumatic metering system 10 for determining flow rate of a pneumatically conveyed bulk material 12 is shown in FIG. 1. The material 12 may be any dry, solid, particulate material, such as, but not limited to, sand and other proppants, salt, seed, shells, dust, powders, and additives, capable of being pneumatically conveyed through a flow line 14, such as a pipe or tube. In one embodiment, a blower 16 may be used to pneumatically convey the material 12 in flow direction 18, however the blower need not be directly connected to the flow line 14. For example, the blower 16 may pressurize a tank (as shown in FIGS. 2 and 3) containing a source of the material 12, which in turn selectively releases the material 12 into the flow line 14. The system 10 includes at least two sensors 20, 22 including at least one bulk material sensor 20 and at least one gas speed sensor 22. In the illustrated embodiment, a first bulk material sensor 20 and a first gas speed sensor 22 are configured to sense an interior 24 of the flow line 14, which may be pneumatically pressurized. However, in an alternative embodiment, the first gas speed sensor 22 or other gas speed sensors 22 may be positioned to detect gas speed within the system 10 at an area of the system 10 that does not pass the material 12. That is, the gas speed sensor 22 may alternatively be positioned on a “clean” side of the system 10 (a portion of the system 10 through which the material 12 does not pass) while the bulk material sensor 20 is positioned on a “dirty” side of the system 10 (a portion of the system 10 through which the material 12 passes). While the gas speed sensor 22 may be positioned on the clean side of the system 10, the bulk material sensor 20 must be positioned on the dirty side of the system 10. Further, while the illustrated embodiment of the system 10 depicts the gas speed sensor 22 arranged to detect gas speed in the flow line 14 at a point downstream of the bulk material sensor 20, the gas speed sensor 22 may alternatively be positioned to detect gas speed in the flow line 14 at a point upstream of the bulk material sensor 20.

One embodiment of the bulk material sensor 20 for detecting a quantity of material 12 in the flow line 14, and that can detect an amount of dry bulk material 12 in a void, is schematically depicted in FIG. 1. The bulk material sensor 20 may be a Doppler radar sensor that emits a sensor signal (electromagnetic waves, such as radio waves or microwaves), and the back-reflected Doppler-shifted energy signal is detected by the sensor 20 as the material 12 moves through the range 26 of the sensor 20 and is contacted by the sensor signal. The bulk material sensor 20 may alternatively be an optical sensor that can detect reflected light from the passing material 12, in which case the optical sensor may additionally include a light source for directing a light signal onto the passing material 12. Other commercially available bulk material sensors that are capable of measuring the quantity of particles in a void, such as a percentage of particles of material within the fluid (air) in the flow line 14 may also be incorporated into the system 10. In the illustrated embodiment, the bulk material sensor 20 includes an attachment section 28 for attaching the bulk material sensor 20 to the flow line 14. The attachment section 28 may include threads as shown, which are engageable with a threaded opening in the flow line 14. Alternatively, the attachment section 28 may be welded or otherwise secured to the flow line 14. In some alternative embodiments, the bulk material sensor 20 need not be directly connected to the flow line 14, but may be arranged fixedly adjacent to the flow line 14, such as in a case where the signal emitted from the bulk material sensor 20 and reflected energy signals from passing particles of bulk material 12 are passable through a wall of the flow line 14 without substantial loss of accuracy in the sensed signal, depicted schematically as 30, emitted from the bulk material sensor 20.

One embodiment of a gas speed sensor 22 for measuring the gas flow speed in the flow line 14 is schematically depicted in FIG. 1. While alternatively termed “airflow” sensor, it should be understood that the gas speed sensor 22 may be capable of detecting speeds of any conveyed gas. Although, in one embodiment, air is employed to pneumatically convey the bulk material 12 through the flow line 14, the system 10 may allow the use of alternative gases there through. The speed of gas flow may be measured in feet/sec, meter/sec, or any other units used to measure speed, to output a gas speed signal, depicted schematically at 32. Various types of gas speed sensors 22 may be used, including various types of anemometers and sensors that use both velocity sensing elements as well as temperature sensing elements to improve the accuracy of the velocity measurements. The gas speed sensor 22 may include at least a portion 23 positioned within the flow line 14. One possible, non-limiting example of a gas speed sensor incorporable within the system 10 is the QuadraTherm flow meter commercially available from Sierra Instruments, Inc., although other commercially available gas speed sensors that are capable of measuring the gas flow speed within the flow line 14 may also be incorporated into the system 10 as the gas speed sensor 22.

With the use of both the bulk material sensor 20 and the gas speed sensor 22, the system 10 is not limited to gravity driven bulk material passage, and does not require airspeed assumptions in order to calculate the flow rate of the passing bulk material 12. That is, the two signals 30, 32 from the bulk material sensor 20 and the gas speed sensor(s) 22 can be sent to a control system 34 to be combined by the controller 34 to calculate a variable accurate determination of bulk material flow rate. The system 10 thus provides the ability to accurately calculate bulk material flow rate at any air speed or product quantity.

One application of the system 10 is shown in FIGS. 2 and 3, where assembly 50 is but one example of how the system 10 may be employed. The assembly 50 includes a dry bulk material vessel, such as tank 52. The tank 52 may be pressurizable. The tank 52 includes at least one entry port 54 for delivering the bulk material 12 into the tank 52, and at least one exit port 56 for allowing the bulk material 12 to exit the tank 52. In the illustrated embodiment, the tank 52 includes three exit ports 56, although any number of exit ports 56 may be provided. As illustrated, the tank 52 is towable on a wheeled trailer bed 58, pullable by a truck (not shown). Alternatively, the tank 52 may be provided on a train platform or other transportable platform such as a floating rig. In yet another alternative embodiment, the tank 52 may simply be provided on a non-movable surface such as the ground or a factory floor.

The exit port(s) 56 of the tank 52 fluidically communicate with the flow line 14. As the flow line 14 is situated at the belly of the tank 52, the flow line 14 may alternatively be termed a “belly line” in the assembly 50. Each exit port 56 may be provided with a separate flow control valve 60 to permit or block the exit of bulk material 12 from the respective exit port 56 into the flow line 14. One or more hoppers 62 may be provided in the tank 52 to direct the bulk material 12 towards respective exit ports 56.

The blower 16 is provided on the trailer bed 58 and provides a source of pneumatic pressure to the assembly 50. The pneumatic pressure may be delivered into the assembly 50 or blocked therefrom by valve 64 (FIG. 2). The blower 16 may provide pneumatic pressure to the tank 52 through line 66. A pressure transducer 68 may be employed on the line 66 to sense the pressure within the assembly 50 that is moving into the tank 52. A flow control valve 70 may permit or block fluidic communication between the blower 16 and the tank 52. The tank 52 is pressurizable by the blower 16 to create exiting flow and a force to the exiting dry bulk material 12 into the flow line 14. The air coming into the tank 52 by the blower 16 may additionally pressurize the tank 52 to a certain degree, such that the airflow speed exiting the tank 52 may actually be greater than airflow speed entering the tank 52 at a specific moment, such as when the airflow has been coming into the tank 52 for a period of time and pressurizing the tank 52 prior to opening the valves 56 at the exit ports 56, and then the valves 56 are opened.

The assembly 50 may further include an aeration line 72 fluidically connected to the blower 16. A valve 74 on the aeration line 72 may permit or block fluid pressure from the blower 16 into the aeration line 72. The aeration line 72 is fluidically connected to an interior 76 of the tank 52 adjacent each exit port 56 such that the air from the aeration line 72 may be used to fluff up the dry bulk material 12 within the tank 52. The aeration line 72 may connect to the hoppers 62 and create a little whirlwind to fluidize the exiting material 12. Upstream of the aeration line 72, the flow line 14 may be connected to the blower 16 by a check valve 78 to allow pressure from the blower 16 to be delivered to an upstream end 80 of the flow line 14. Such pneumatic pressure may be permitted or blocked by valve 82, and sensed by pressure transducer 84. Thus, the lines 66, 86, 88, 90, and 92 that are in fluidic communication with the blower 16 are split and controlled by the various flow control valves 64, 70, 74, and 82 for selectively directing pneumatic pressure from the blower 16 into the tank 52, flow line 14, and aeration line 72.

The flow line 14 provides a flow path for the dry bulk material 12 to escape the assembly 50. That is, the material 12 is moved in direction 18 to an exit 94 and discharge portion 95 of the assembly 50. In the illustrated assembly 50, two sensors 20, 22 are employed adjacent an end of the trailer bed 58 and close to the exit 94 of the assembly 50. The sensors 20, 22 may be welded or otherwise secured to, or relative to, the product line 14. In the illustrated embodiment, both sensors 20, 22 are located on the downstream “dirty” side of the assembly 50. Additional sensor(s) 22 are depicted on the upstream “clean” side of the assembly 50. The gas speed sensor(s) 22 may be included at one or more of the depicted locations, and for different assemblies the locations for the gas speed sensor(s) 22 may be adjusted accordingly. Signals 30, 32 from the sensors 20, 22 are provided to the controller 34 (FIG. 1) which may be provided in control housing 96 (FIG. 3).

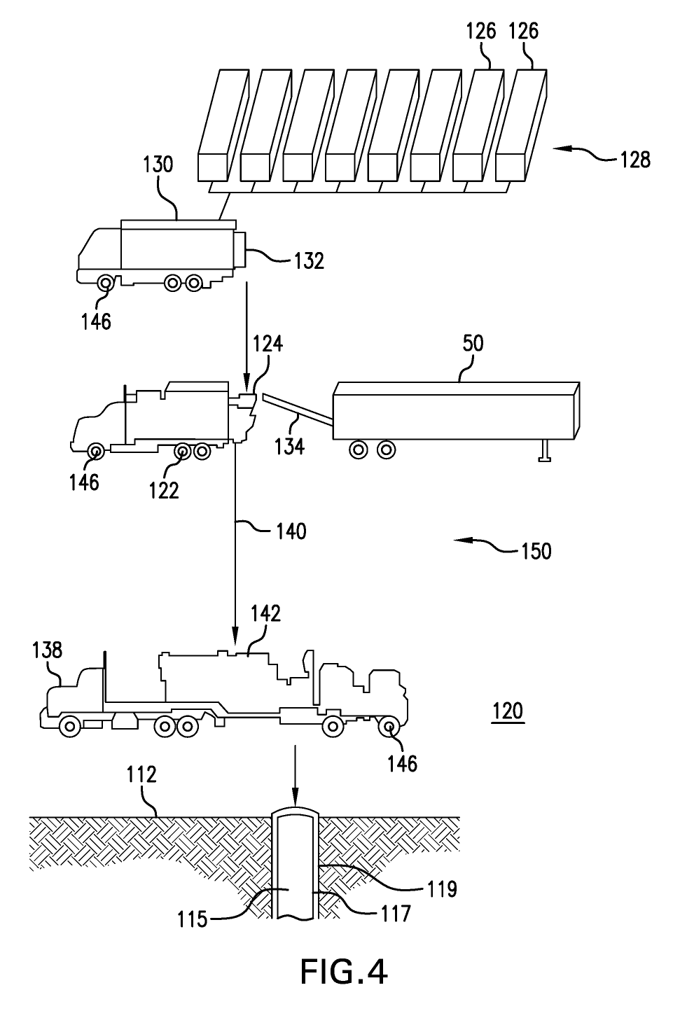

With reference now to FIG. 4, the assembly 50 containing the system 10 is depicted at a location within an operation system 150. In the illustrated embodiment, the location is a wellsite 120 and the operation system 150 is for a hydraulic fracturing operation. While the system 10 may be used in a number of different manufacturing and industry environments, the system 10 is particularly useful in a hydraulic fracturing operation for pumping a fluid, such as a hydraulic fracturing fluid, from a surface 112 to a borehole 115. The borehole 115 may be cased or uncased, or include any other tubular 117 provided with perforations or openings for fracturing fluid to pass towards the formation wall 119. The operation system 150 (a fluid processing system) includes a blender 122. The blender 122 includes, in part, a blender tank or tub 124 for blending components of the fracturing fluid. Components of the fracturing fluid may include a base fluid (such as water), material 112 (such as proppant/sand), and various other additives to form a slurry of the hydraulic fracturing fluid. The base fluid may be stored in one or more water tanks 126 in a fluid supply 128. In one embodiment, prior to blending, the base fluid may be passed through a hydration system 130, which combines the base fluid with additives for a sufficient amount of residence time within a hydration tank 132 of the hydration system 130 to form a gel. The gel from the hydration tank 132 may then be directed to the blender 122 for combining with bulk material 12, such as proppants, stored in sand trucks, silos or other sources, such as tank 52 (FIGS. 2 and 3), which may be positioned to pass the bulk material 12 through the system 10 prior to delivering the material 12 to the blender 122. The material 12 may, in one embodiment, be delivered to the blender tub 124 using a conveyor system 134. Knowing the flow rate of the material 12 being delivered into the blender tub 124 is useful information for correctly adjusting the quantities of the components of the fracturing fluid. The fracturing fluid is pumped from the blender 122 to a fracturing pump assembly 138 along line 140. The fracturing pump assembly 138 may include one or more fracturing pumps 142 (also known as “frac” pumps). While only one fracturing pump assembly 138 is depicted, a manifold may provide the fracturing fluid to multiple fracturing pump assemblies 138. The hydraulic fracturing fluid is then deliverable into the borehole 115 at high pressures by the one or more fracturing pump assemblies 138.

Any or all of the components of the system 150, including the blender 122, hydration system 130, conveyor system 134, fluid supply 128, pneumatic bulk material assembly 50, and fracturing pump assembly 138 may be provided on trailer beds, trucks, or other movable/wheeled platform or transportable surfaces 146 to assist in delivery of the components to the well site 120, and to enable such components to be reconfigured as needed at the wellsite 120, and quickly removed from the well site 120 when the process is completed. Alternatively, in an embodiment where the system 150 is utilized for an offshore well, the components may be positioned on a suitable fracturing and stimulation vessel (not shown).

While particular arrangements of a system 10, assembly 50 and operation 150 have been shown in FIGS. 1-4, it should be understood that the system 10 may have alternate arrangements and may be incorporated into alternate assemblies, operations, and methods where bulk material 12 is blown into a line and carried pneumatically.

Thus, the system 10 described herein looks at bulk material 12 in a flow line 14 being conveyed pneumatically and uses a combination of signals 32, 30 from a sensor 22 to measure air speed and a sensor 20 to measure particles in the air within the flow line 14 to calculate a bulk material flow rate of the bulk material 12. The system 10 can be fully contained in a pneumatically pressurized environment by the arrangement of the sensors 20, 22 relative to the flow line 14. The sensor 22 detects and measures the gas flow and outputs a gas flow rate. The sensor 20 detects the amount of bulk materials 12 in the detection range 26 and outputs a quantity or a percent of material 12 in the range 26. These two signals 30, 32 are combined together to calculate a variable accurate determination of bulk material flow rate. The system 10 advantageously is able to accurately determine bulk material flow rate at any air speed. Calculating measurements from the two sensors 20, 22 together may change slightly depending on different sensors 20, 22 used. Also, for different assemblies, proper placement of sensors 20, 22 for accurate readings may be altered. Further, different types of sensors 20, 22 will affect the accuracy of the results, and the determination of which type of sensors 20, 22 is employed in a particular assembly may depend on environment, cost, ease of use, etc.

Set forth below are some embodiments of the foregoing disclosure:

Embodiment 1: A dry bulk pneumatic metering system comprising: a flow line configured for the passage of pneumatically-conveyed bulk material; a bulk material sensor arranged relative to the flow line, the bulk material sensor configured to send a first signal related to a quantity of the bulk material passing in the flow line and within a range of the bulk material sensor; a speed sensor arranged with respect to at least one area of the system, the speed sensor configured to send a second signal related to the speed of gas flow at the at least one area of the system; and, a controller arranged to receive the first and second signals and configured to calculate a bulk material flow rate of the bulk material using the first and second signals.

Embodiment 2: The dry bulk pneumatic metering system of any of the proceeding embodiments, wherein the speed sensor includes at least one portion arranged within the flow line.

Embodiment 3: The dry bulk pneumatic metering system of any of the proceeding embodiments, wherein the bulk material sensor utilizes one of an optical signal and a radar signal.

Embodiment 4: The dry bulk pneumatic metering system of any of the proceeding embodiments, further comprising a plurality of speed sensors.

Embodiment 5: The dry bulk pneumatic metering system of any of the proceeding embodiments, wherein the at least one area of the system does not pass the bulk material therethrough.

Embodiment 6: The dry bulk pneumatic metering system of any of the proceeding embodiments, further comprising a pressurizable tank configured to hold a source of the bulk material, the tank including at least one exit port fluidically connected to the flow line.

Embodiment 7: The dry bulk pneumatic metering system of any of the proceeding embodiments, further comprising a blower arranged to pressurize the pressurizable tank.

Embodiment 8: The dry bulk pneumatic metering system of any of the proceeding embodiments, further comprising a blower line connecting the blower and the flow line, the blower line bypassing the tank.

Embodiment 9: The dry bulk pneumatic metering system of any of the proceeding embodiments, further comprising an aeration line fluidically connected to the blower line, the aeration line arranged to blow gas into the tank adjacent the at least one exit port.

Embodiment 10: An operating system comprising: a material receiving member; and, the dry bulk pneumatic metering system of claim 1, the dry bulk pneumatic metering system further including a discharge portion arranged to discharge the bulk material from the dry bulk pneumatic metering system; wherein the bulk material discharged from the dry bulk pneumatic metering system is delivered to the material receiving member.

Embodiment 11: The operating system of any of the proceeding embodiments, wherein the material receiving member is one of a blender tub, a mixing tub, and a tank.

Embodiment 12: The operating system of any of the proceeding embodiments, wherein the bulk material is used in the material receiving member to blend a hydraulic fracturing fluid.

Embodiment 13: The operating system of any of the proceeding embodiments, wherein the material receiving member is a blender, and further comprising a high pressure fracturing pump configured to receive the hydraulic fracturing fluid from the blender.

Embodiment 14: A method of determining a bulk material flow rate in a dry bulk pneumatic metering system, the method comprising: pneumatically conveying bulk material through a flow line of the system; sensing a quantity of the bulk material passing within the flow line and within a range of a bulk material sensor, the bulk material sensor arranged relative to the flow line, the bulk material sensor sending a first signal to a controller of the system; sensing a speed of gas flow at at least one area of the system using a speed sensor, the speed sensor sending a second signal to the controller; and, using the first and second signals in the controller to calculate the bulk material flow rate of the bulk material.

Embodiment 15: The method of any of the proceeding embodiments, wherein pneumatically conveying bulk material through the flow line includes pneumatically conveying the bulk material at variable rates.

Embodiment 16: The method of any of the proceeding embodiments, wherein pneumatically conveying bulk material through the flow line includes using a blower for conveyance.

Embodiment 17: The method of any of the proceeding embodiments, further comprising supplying the flow line with the bulk material from a tank containing a source of the bulk material, the tank having an exit port in fluid communication with the flow line, and pressurizing the tank with the blower.

Embodiment 18: The method of any of the proceeding embodiments, wherein sensing the quantity of the bulk material includes using one of a radar and an optical signal.

Embodiment 19: The method of any of the proceeding embodiments, wherein sensing the speed of gas flow at at least one area of the system using the speed sensor includes sensing the speed of gas flow at an area of the system through which the bulk material does not pass.

Embodiment 20. The method of any of the proceeding embodiments, wherein sensing the speed of gas flow at at least one area of the system using the speed sensor includes sensing the speed of gas flow in the flow line.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A dry bulk pneumatic metering system comprising:
a flow line configured for the passage of pneumatically-conveyed bulk material;
a bulk material sensor arranged relative to the flow line, the bulk material sensor configured to send a first signal related to a quantity of the bulk material passing in the flow line and within a range of the bulk material sensor;
a speed sensor arranged with respect to at least one area of the system, the speed sensor configured to send a second signal related to the speed of gas flow at the at least one area of the system; and,
a controller arranged to receive the first and second signals and configured to calculate a bulk material flow rate of the bulk material using the first and second signals.

2. The dry bulk pneumatic metering system of claim 1, wherein the speed sensor includes at least one portion arranged within the flow line.

3. The dry bulk pneumatic metering system of claim 1, wherein the bulk material sensor utilizes one of an optical signal and a radar signal.

4. The dry bulk pneumatic metering system of claim 1, further comprising a plurality of speed sensors.

5. The dry bulk pneumatic metering system of claim 1, wherein the at least one area of the system does not pass the bulk material therethrough.

6. The dry bulk pneumatic metering system of claim 1, further comprising a pressurizable tank configured to hold a source of the bulk material, the tank including at least one exit port fluidically connected to the flow line.

7. The dry bulk pneumatic metering system of claim 6, further comprising a blower arranged to pressurize the pressurizable tank.

8. The dry bulk pneumatic metering system of claim 7, further comprising a blower line connecting the blower and the flow line, the blower line bypassing the tank.

9. The dry bulk pneumatic metering system of claim 8, further comprising an aeration line fluidically connected to the blower line, the aeration line arranged to blow gas into the tank adjacent the at least one exit port.

10. An operating system comprising:
a material receiving member; and,
the dry bulk pneumatic metering system of claim 1, the dry bulk pneumatic metering system further including a discharge portion arranged to discharge the bulk material from the dry bulk pneumatic metering system;
wherein the bulk material discharged from the dry bulk pneumatic metering system is delivered to the material receiving member.

11. The operating system of claim 10, wherein the material receiving member is one of a blender tub, a mixing tub, and a tank.

12. The operating system of claim 10, wherein the bulk material is used in the material receiving member to blend a hydraulic fracturing fluid.

13. The operating system of claim 12, wherein the material receiving member is a blender, and further comprising a high pressure fracturing pump configured to receive the hydraulic fracturing fluid from the blender.

14. A method of determining a bulk material flow rate in a dry bulk pneumatic metering system, the method comprising:
pneumatically conveying bulk material through a flow line of the system;
sensing a quantity of the bulk material passing within the flow line and within a range of a bulk material sensor, the bulk material sensor arranged relative to the flow line, the bulk material sensor sending a first signal to a controller of the system;
sensing a speed of gas flow at at least one area of the system using a speed sensor, the speed sensor sending a second signal to the controller; and,
using the first and second signals in the controller to calculate the bulk material flow rate of the bulk material.

15. The method of claim 14, wherein pneumatically conveying bulk material through the flow line includes pneumatically conveying the bulk material at variable rates.

16. The method of claim 14, wherein pneumatically conveying bulk material through the flow line includes using a blower for conveyance.

17. The method of claim 16, further comprising supplying the flow line with the bulk material from a tank containing a source of the bulk material, the tank having an exit port in fluid communication with the flow line, and pressurizing the tank with the blower.

18. The method of claim 14, wherein sensing the quantity of the bulk material includes using one of a radar and an optical signal.

19. The method of claim 14, wherein sensing the speed of gas flow at at least one area of the system using the speed sensor includes sensing the speed of gas flow at an area of the system through which the bulk material does not pass.

20. The method of claim 14, wherein sensing the speed of gas flow at at least one area of the system using the speed sensor includes sensing the speed of gas flow in the flow line.
